(19) United States
(12) Patent Application Publication
(10) Pub. No.: US 2023/0258268 A1
(43) Pub. Date: Aug. 17, 2023

(54) SEALING DEVICE AND ROTARY MACHINE

(71) Applicant: MITSUBISHI HEAVY INDUSTRIES, LTD., Tokyo (JP)

(72) Inventors: Takashi Mitsumata, Tokyo (JP); Kohei Ozaki, Tokyo (JP); Azumi Yoshida, Tokyo (JP); Masaya Kawano, Tokyo (JP)

(73) Assignee: MITSUBISHI HEAVY INDUSTRIES, LTD., Tokyo (JP)

(21) Appl. No.: 18/161,919

(22) Filed: Jan. 31, 2023

(30) Foreign Application Priority Data
Feb. 16, 2022 (JP) 2022-022361

(51) Int. Cl. F01D 11/02

(52) U.S. Cl. CPC F01D 11/02; F05D 2220/31; F05D 2240/55

(57) ABSTRACT

A sealing device is disposed between a stationary body and a rotating body and is configured to suppress flow of a fluid from a high-pressure side to a low-pressure side. The sealing device includes: a sealing member movably supported by the stationary body in an axial direction and a radial direction of the rotating body; a seal fin extending from the sealing member to the rotating body side; a pressure adjustment space provided between the stationary body and a high-pressure-side end surface of the sealing member; and a communication passage having one end communicating with the low-pressure side and the other end communicating with the pressure adjustment space.

### CROSS-REFERENCE TO RELATED APPLICATIONS

This application claims the benefit of priority to Japanese Patent Application Number 2022-022361 filed on Feb. 16, 2022. The entire contents of the above-identified application are hereby incorporated by reference.

### TECHNICAL FIELD

The disclosure relates to a sealing device that prevents fluid leakage between a stationary body and a rotating body, and a rotary machine including the sealing device.

### RELATED ART

The rotary machine includes a rotating body rotatably supported inside a casing that is a stationary body. The sealing device is provided between the casing and the rotating body to prevent a leakage flow of the fluid in the axial direction. A labyrinth seal is generally applied to the sealing device. The labyrinth seal is provided in an inner circumferential portion of the casing and has a plurality of seal fins. The sealing device generates a pressure loss by a gap formed between the seal fin and the rotating body, and suppresses a fluid leakage flow in the axial direction by the pressure loss.

Such sealing devices include one described in JP 2017-057841 A, for example. In the sealing device described in JP 2017-057841 A, the packing ring segment is supported movably by the packing ring holder along the axial direction and the radial direction, and the packing ring segment is biased and supported on the high-pressure chamber side by an elastic body. Then, the packing ring segment moves inward in the radial direction by the pressure on the high-pressure chamber side, and the gap between the seal fin and the rotating body is adjusted. At this time, the packing ring segment is biased and supported on the high-pressure chamber side by the elastic body, and sliding resistance with a packing ring holder is reduced.

### SUMMARY

In the known sealing device, the packing ring segment is biased and supported on the high-pressure chamber side by the elastic body, thereby reducing sliding resistance with the packing ring holder. In this case, the biasing force of the packing ring segment by the elastic body is constant, and the biasing force is set by the differential pressure between the high-pressure chamber side and the low-pressure chamber side. However, the pressure on the high-pressure chamber side fluctuates according to the operating state of the rotary machine. Therefore, when the pressure on the high-pressure chamber side fluctuates, the pressing force with which the packing ring segment is pressed against the packing ring holder fluctuates, and the sliding resistance between the packing ring segment and the packing ring holder fluctuates. Then, there is a risk that the packing ring segment does not smoothly operate with respect to the packing ring holder according to the operating state of the rotary machine, and the sealing performance deteriorates.

The disclosure has been made to solve the above-described problems, and an object of the disclosure is to provide a sealing device and a rotary machine capable of maintaining stable sealing performance by smoothly operating a sealing member regardless of pressure fluctuation.

A sealing device of the disclosure for achieving the above object is a sealing device disposed between a stationary body and a rotating body and configured to suppress flow of a fluid from a high-pressure side to a low-pressure side. The sealing device includes: a sealing member movably supported by the stationary body in an axial direction and a radial direction of the rotating body, a seal fin extending from the sealing member to the rotating body side, a pressure adjustment space provided between the stationary body and a high-pressure-side end surface of the sealing member, and a communication passage having one end communicating with the low-pressure side and the other end communicating with the pressure adjustment space.

A rotary machine of the disclosure includes a stationary body; a rotating body rotatably supported by the stationary body; and the sealing device disposed between the stationary body and the rotating body.

With the sealing device and the rotary machine of the disclosure, it is possible to maintain stable sealing performance by smoothly operating a sealing member regardless of pressure fluctuation.

### BRIEF DESCRIPTION OF DRAWINGS

The disclosure will be described with reference to the accompanying drawings, wherein like numbers reference like elements.

FIG. 1 is a schematic diagram illustrating an internal configuration of a steam turbine.

FIG. 2 is a cross-sectional view illustrating a sealing device of a first embodiment.

FIG. 3 is a cross-sectional view taken along line III-III of FIG. 2 illustrating a sealing member.

FIG. 4 is a cross-sectional view illustrating the sealing device of the second embodiment.

FIG. 5 is a cross-sectional view illustrating a sealing device of a third embodiment.

FIG. 6 is a cross-sectional view illustrating a sealing device of a fourth embodiment.

FIG. 7 is a cross-sectional view illustrating a sealing device of a fifth embodiment.

### DESCRIPTION OF EMBODIMENTS

Hereinafter, preferred embodiments of the disclosure will be described in detail with reference to drawings. Note that the disclosure is not limited to these embodiments, and when there are a plurality of embodiments, the disclosure is intended to include a configuration combining these embodiments. In addition, configuration elements in the embodiments include those that can be easily assumed by those having skill in the art, those that are substantially the same, and those with a so-called equivalent scope.

### First Embodiment

### Steam Turbine

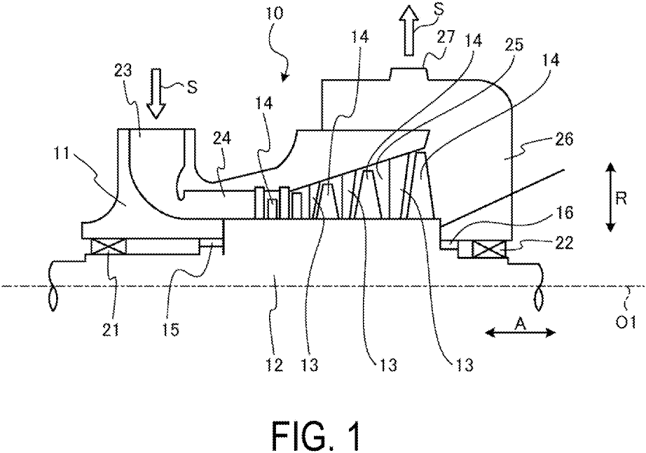

FIG. 1 is a schematic diagram illustrating an internal configuration of a steam turbine.

In the first embodiment, a steam turbine is applied and described as a rotary machine. However, the rotary machine is not limited to the steam turbine, and may have a configuration in which a rotating body is rotatably supported with respect to a stationary body.

As illustrated in FIG. 1, a steam turbine (rotary machine) 10 includes a casing (stationary body) 11, a rotor (rotating body) 12, a stator vane 13, a rotor blade 14, and sealing devices 15 and 16.

The casing 11 has a hollow shape in which the rotor 12 is disposed along the horizontal direction. The rotor 12 is rotatably supported about an axial center O1 by bearings 21 and 22 provided in the casing 11. A plurality of the stator vanes 13 are fixed to the inner circumferential portion of the casing 11 at intervals in an axial direction A of the rotor 12. A plurality of the rotor blades 14 are fixed to the outer circumferential portion of the rotor 12 at intervals in the axial direction A. The stator vanes 13 are arranged at intervals in the circumferential direction of the rotor 12, along a radial direction R of the rotor 12. The rotor blades 14 are arranged at intervals in the circumferential direction of the rotor 12 along the radial direction R of the rotor 12, and the stator vanes 13 and the rotor blades 14 are alternately arranged in the axial direction A.

The casing 11 is provided with a steam supply port 23 at one end in the axial direction A. The steam supply port 23 communicates with a vane/blade row portion 25 in which the stator vanes 13 and the rotor blades 14 are arranged via a steam passage 24. The vane/blade row portion 25 communicates with an exhaust chamber 26. The casing 11 is provided with a steam discharge port 27 at the other end in the axial direction A. The steam discharge port 27 communicates with the exhaust chamber 26.

The sealing device 15 is disposed between the casing 11 and the rotor 12 on one end side in the axial direction A. The sealing device 15 is a labyrinth seal and provided in the inner circumferential portion of the casing 11. The sealing device 15 generates a pressure loss by a gap formed between the seal fin and the rotor 12, and suppresses a fluid leakage flow in the axial direction by the pressure loss. The sealing device 16 is also similar to the sealing device 15.

High-pressure steam S is supplied from the steam supply port 23 to the vane/blade row portion 25 through the steam passage 24. When the steam S passes through the plurality of stator vanes 13 and the plurality of rotor blades 14, the rotor 12 is driven and rotated via each rotor blade 14. A generator not illustrated is coupled to the rotor 12, and the generator is driven by a driving force of the rotor 12. Upon driving each rotor blade 14, the steam S is discharged from the steam discharge port 27 to the outside through the exhaust chamber 26.

### Configuration of Sealing Device

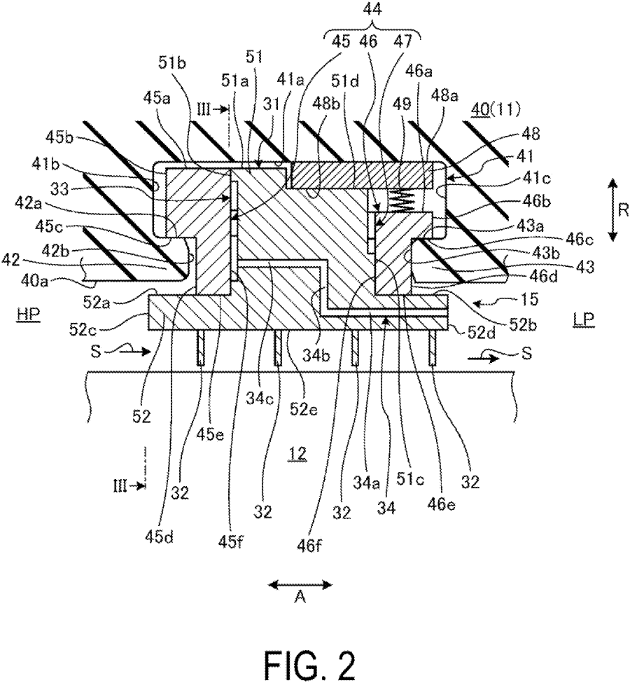

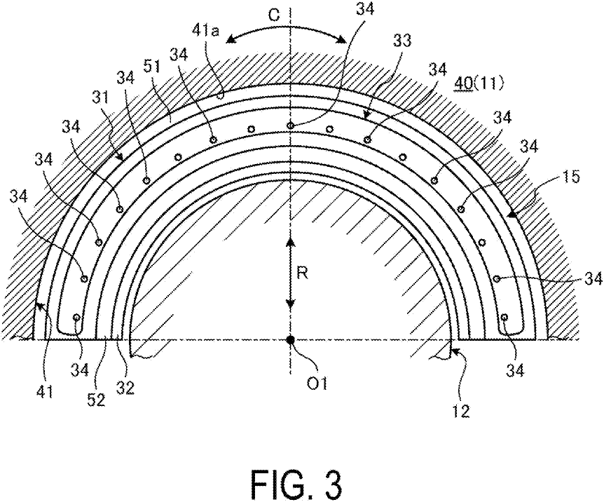

FIG. 2 is a cross-sectional view illustrating the sealing device of the first embodiment, and FIG. 3 is a cross-sectional view taken along line III-III of FIG. 2 illustrating a sealing member.

As illustrated in FIGS. 2 and 3, the sealing device 15 is disposed between the casing (stationary body) 11 and the rotor (rotating body) 12, and suppresses the flow of the steam (fluid) S from a high-pressure space HP on the high-pressure side to a low-pressure space LP on the low-pressure side. The sealing device 15 includes a sealing member 31, a seal fin 32, a pressure adjustment space 33, and a communication passage 34.

A sealing holder 40 is fixed to the casing 11. The sealing holder 40 has a ring shape continuous in a circumferential direction C. However, the sealing holder 40 may be divided into a plurality of parts in the circumferential direction. The sealing holder 40 is provided with a recess 41 in an inner circumferential portion. The recess 41 is formed to be recessed outward in the radial direction R of the rotor 12 from an inside surface 40a of the sealing holder 40. The recess 41 has a ring shape continuous in the circumferential direction C. The recess 41 has a bottom surface 41a, a high-pressure-side lateral surface 41b, and a low-pressure-side lateral surface 41c. The recess 41 is provided with a high-pressure-side protrusion 42 protruding on the low-pressure space LP side from inside in the radial direction R of the high-pressure-side lateral surface 41b. The high-pressure-side protrusion 42 has an inner surface 42a and a high-pressure-side lateral surface 42b. The recess 41 is provided with a low-pressure-side protrusion 43 protruding on the high-pressure space HP side from inside in the radial direction R of the low-pressure-side lateral surface 41c. The low-pressure-side protrusion 43 has an inner surface 43a and a low-pressure-side lateral surface 43b. The recess 41 has a T-shaped cross-sectional shape when provided with the high-pressure-side protrusion 42 and the low-pressure-side protrusion 43.

In the casing 11, a retainer 44 is mounted in the recess 41 of the sealing holder 40. The retainer 44 functions as a stationary body. The retainer 44 has a ring shape continuous in the circumferential direction C. However, the retainer 44 may be divided into a plurality of parts in the circumferential direction. The retainer 44 includes a high-pressure-side retainer 45 and a low-pressure-side retainer 46. The high-pressure-side retainer 45 and the low-pressure-side retainer 46 are integrally coupled by a coupling portion 47.

In the retainer 44, the high-pressure-side retainer 45 is supported by the high-pressure-side protrusion 42, and the low-pressure-side retainer 46 is supported by the low-pressure-side protrusion 43. That is, the high-pressure-side retainer 45 has an L-shaped cross-sectional shape and includes an outside surface 45a, a high-pressure-side first lateral surface 45b, a locking surface 45c, a high-pressure-side second lateral surface 45d, an inside surface 45e, and a low-pressure-side lateral surface 45f. The low-pressure-side retainer 46 has an L-shaped cross-sectional shape and includes an outside surface 46a, a low-pressure-side first lateral surface 46b, a locking surface 46c, a low-pressure-side second lateral surface 46d, an inside surface 46e, and a high-pressure-side lateral surface 46f.

The retainer 44 is disposed in the recess 41 of the sealing holder 40. In the high-pressure-side retainer 45, the locking surface 45c comes into contact with the inner surface 42a of the high-pressure-side protrusion 42, and the high-pressure-side second lateral surface 45d opposes the high-pressure-side lateral surface 42b. In the low-pressure-side retainer 46, the locking surface 46c comes into contact with the inner surface 43a of the low-pressure-side protrusion 43, and the low-pressure-side second lateral surface 46d opposes the low-pressure-side lateral surface 43b. Therefore, the retainer 44 is positioned in the casing 11 by being disposed in the recess 41 of the sealing holder 40.

The sealing member 31 is supported by the retainer 44. The sealing member 31 has a ring shape continuous in the circumferential direction C. However, similarly to the retainer 44, the sealing member 31 may be divided into a plurality of parts in the circumferential direction. The sealing member 31 is movably supported along the axial direction A and the radial direction R by the retainer 44. The sealing member 31 includes a support portion 51 and a fin attachment portion 52. The support portion 51 has a quadrangular cross-sectional shape, and is disposed inside the recess 41 between the high-pressure-side retainer 45 and the low-pressure-side retainer 46. The support portion 51 has an outside surface 51a, a high-pressure-side end surface 51b, and a low-pressure-side end surface 51c. The high-pressure-side end surface 51b of the support portion 51 opposes the low-pressure-side lateral surface 45f of the high-pressure-side retainer 45 and can come into contact therewith. The low-pressure-side end surface 51c of the support portion 51 opposes the high-pressure-side lateral surface 46f of the low-pressure-side retainer 46 and can come into contact therewith.

The fin attachment portion 52 is integrally provided inside in the radial direction R of the support portion 51. The fin attachment portion 52 has a quadrangular cross-sectional shape elongated in the axial direction A, and is disposed on an inner circumferential side of the high-pressure-side retainer 45 and the low-pressure-side retainer 46 inside in the radial direction R of the recess 41. The fin attachment portion 52 extends from the support portion 51 on the rotor 12 side. The fin attachment portion 52 has a high-pressure-side outside surface 52a, a low-pressure-side outside surface 52b, a high-pressure-side lateral surface 52c, a low-pressure-side lateral surface 52d, and an inside surface 52e.

The seal fin 32 extends from the fin attachment portion 52 of the sealing member 31 on the rotor 12 side. A plurality of (in the present embodiment, four) the seal fins 32 are provided at intervals in the axial direction A. The seal fin 32 is provided continuously in the circumferential direction C. The seal fin 32 is fixed to the inside surface 52e of the fin attachment portion 52 in the sealing member 31. However, the number of the seal fins 32 is not limited to four, and only required to be appropriately set according to the length in the axial direction A to be sealed. The plurality of seal fins 32 are arranged at equal intervals in the axial direction A, but may be positioned at unequal intervals.

A spring reception member 48 is fixed to the outside surface 51a side of the sealing member 31. The spring reception member 48 is disposed in the recess 41 of the sealing holder 40. The spring reception member 48 has a rectangular cross-sectional shape elongated in the axial direction A and has a ring shape continuous in the circumferential direction C. However, the spring reception member 48 may be divided into a plurality of parts in the circumferential direction. The spring reception member 48 is fixed to a stepped portion 51d formed on the outside surface 51a of the support portion 51 in the sealing member 31. In the spring reception member 48, an outside surface 48a is disposed to oppose the bottom surface 41a of the recess 41, and an inside surface 48b is disposed to oppose the outside surface 46a of the low-pressure-side retainer 46. A compression spring (biasing member) 49 is disposed between the low-pressure-side retainer 46 and the spring reception member 48. The compression spring 49 biases the sealing member 31 via the spring reception member 48 in the radial direction R in which the seal fin 32 is separated from the rotor 12 by the biasing force.

Therefore, the sealing member 31 is positioned at a position where the spring reception member 48 comes into contact with the bottom surface 41a of the recess 41 by the biasing force of the compression spring 49. When the steam S in the high-pressure space HP enters the recess 41 and acts on the outside surface 51a side of the support portion 51, the sealing member 31 becomes movable with respect to the retainer 44 toward the radial direction R in which the seal fin 32 approaches the rotor 12 against the biasing force of the compression spring 49. Although the sealing member 31 is disposed between the high-pressure-side retainer 45 and the low-pressure-side retainer 46, the sealing member 31 is supported movably in the axial direction A with respect to the retainer 44 by an amount of an attachment gap between them.

The pressure adjustment space 33 is provided in the support portion 51 of the sealing member 31. Specifically, the pressure adjustment space 33 is provided on the high-pressure-side end surface 51b of the support portion 51 in the sealing member 31. The pressure adjustment space 33 is formed by providing the high-pressure-side end surface 51b of the sealing member 31 with a recess. The pressure adjustment space 33 opposes the low-pressure-side lateral surface 45f of the high-pressure-side retainer 45. That is, the pressure adjustment space 33 is a space formed between the high-pressure-side end surface 51b in the support portion 51 of the sealing member 31 and the low-pressure-side lateral surface 45f of the high-pressure-side retainer 45 when they come into contact with each other. The pressure adjustment space 33 is provided along the circumferential direction C. In the first embodiment, since the sealing member 31 is divided into two in the circumferential direction, each end in the circumferential direction of the pressure adjustment space 33 is closed. However, the pressure adjustment space 33 may be continuous in the circumferential direction C of the sealing member 31 or may be divided into a plurality of parts in the circumferential direction.

The communication passage 34 has one end communicating with a low-pressure-side space LP, and the other end communicating with the pressure adjustment space 33. The communication passage 34 is provided along the axial direction A and arranged at an interval from the circumferential direction C. The communication passage 34 includes a first communication passage 34a along the axial direction A, a second communication passage 34b along the radial direction R, and a third communication passage 34c along the axial direction A. The first communication passage 34a has one end opening to the low-pressure-side lateral surface 52d of the fin attachment portion 52. The third communication passage 34c has one end opening to the low-pressure-side space LP. The second communication passage 34b has one end communicating with the other end of the first communication passage 34a and the other end communicating with the other end of the third communication passage 34c. The communication passage 34 is not limited to this configuration, and for example, the low-pressure-side space LP and the pressure adjustment space 33 may be configured by one or two flow paths having a linear shape.

### Actions of Sealing Device

As illustrated in FIG. 2, before start of the steam turbine 10 (see FIG. 1), there is no differential pressure between the high-pressure-side space HP and the low-pressure-side space LP. Therefore, the sealing member 31 is positioned at a position where the spring reception member 48 comes into contact with the bottom surface 41a of the recess 41 by the biasing force of the compression spring 49, and a gap between the tip portion of the seal fin 32 and the outside surface of the rotor 12 is maximized.

When the steam turbine 10 (see FIG. 1) is started, since the high-pressure steam S is supplied to the high-pressure-side space HP, a differential pressure is generated between the high-pressure-side space HP and the low-pressure-side space LP. At this time, the steam S in the high-pressure-side space HP partially leaks to the low-pressure-side space LP through the gap between the seal fin 32 and the rotor 12. The steam S partially passes through between the sealing holder 40 and the high-pressure-side retainer 45 and enters the outside surface 51a side of the support portion 51 in the sealing member 31. Then, the sealing member 31 is pressed inward in the radial direction R by the steam S in the high-pressure space HP, and moves inward in the radial direction R against the biasing force of the compression spring 49. Then, the gap between the tip portion of the seal fin 32 and the outside surface of the rotor 12 becomes small, a pressure loss occurs due to a minute gap, and a leakage flow of the steam S flowing through the gap in the axial direction A is suppressed by the pressure loss.

At this time, the high-pressure steam S in the high-pressure-side space HP acts on the high-pressure-side first lateral surface 45b of the high-pressure-side retainer 45, whereby the retainer 44 is pressed to one side (rightward in FIG. 2) in the axial direction A of the steam S. The high-pressure steam S in the high-pressure-side space HP acts on the low-pressure-side end surface 51c of the sealing member 31, whereby the sealing member 31 is pressed in the other direction (leftward in FIG. 2) in the axial direction A of the steam S. Therefore, the pressing force between the low-pressure-side lateral surface 45f of the high-pressure-side retainer 45 and the high-pressure-side end surface 51b of the sealing member 31 increases, and the sliding resistance against the retainer 44 when the sealing member 31 moves in the radial direction R increases.

In the first embodiment, the low-pressure steam S in the low-pressure-side space LP is supplied to the pressure adjustment space 33 through the communication passage 34. Then, since the pressure in the pressure adjustment space 33 acts on the low-pressure-side lateral surface 45f of the high-pressure-side retainer 45 and the high-pressure-side end surface 51b of the sealing member 31, the pressing force between the low-pressure-side lateral surface 45f of the high-pressure-side retainer 45 and the high-pressure-side end surface 51b of the sealing member 31 is reduced. Therefore, the sliding resistance against the retainer 44 when the sealing member 31 moves in the radial direction R is reduced and becomes small. As a result, the sealing member 31 can smoothly move in the radial direction R in accordance with the differential pressure between the high-pressure-side space HP and the low-pressure-side space LP.

When the pressure of the steam S in the high-pressure-side space HP fluctuates, the pressing force between the high-pressure-side retainer 45 and the sealing member 31 fluctuates. At this time, the differential pressure between the high-pressure-side space HP and the low-pressure-side space LP also fluctuates. That is, the pressing force between the high-pressure-side retainer 45 and the sealing member 31 is appropriately adjusted in accordance with the fluctuation of the high-pressure-side space HP. As a result, the sliding resistance against the retainer 44 when the sealing member 31 moves in the radial direction R is appropriately adjusted.

### Second Embodiment

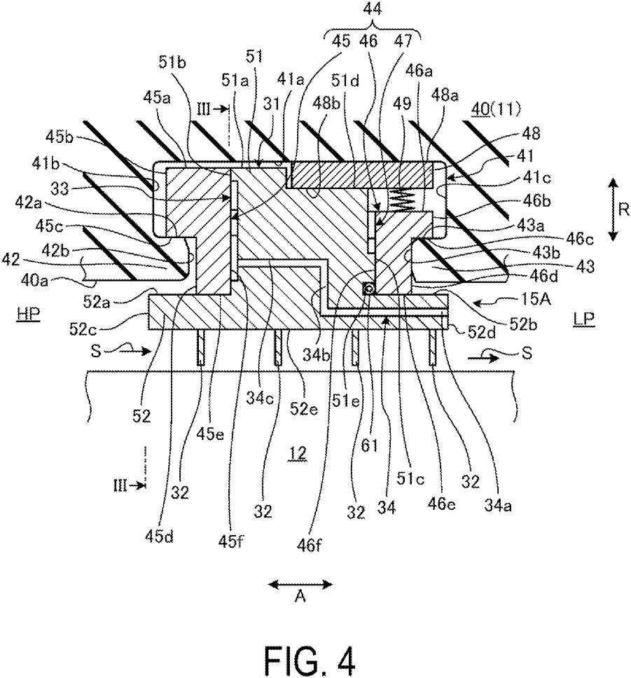

FIG. 4 is a cross-sectional view illustrating a sealing device of the second embodiment. Members having the same functions as those of the above-described first embodiment are denoted by the same reference signs, and detailed description thereof will be omitted.

As illustrated in FIG. 4, a sealing device 15A includes the sealing member 31, the seal fin 32, the pressure adjustment space 33, and the communication passage 34.

The sealing holder 40 is fixed to the casing 11, and the sealing holder 40 is provided with the recess 41. The retainer 44 is mounted in the recess 41 of the sealing holder 40. The retainer 44 is configured such that the high-pressure-side retainer 45 and the low-pressure-side retainer 46 are integrally coupled by the coupling portion 47. The sealing member 31 is supported movably along the axial direction A and the radial direction R by the retainer 44. The sealing member 31 is provided with the plurality of seal fins 32 on the inner circumferential portion side of the radial direction R. In the sealing member 31, the spring reception member 48 is fixed to the stepped portion 51d. The compression spring 49 is disposed between the low-pressure-side retainer 46 and the spring reception member 48. The compression spring 49 biases the sealing member 31 outward in the radial direction R.

The pressure adjustment space 33 is configured by forming a recess in the high-pressure-side end surface 51b of the sealing member 31. The pressure adjustment space 33 is brought into a sealed state when the high-pressure-side end surface 51b in the support portion 51 of the sealing member 31 and the low-pressure-side lateral surface 45f of the high-pressure-side retainer 45 come into contact with each other. The communication passage 34 has one end communicating with the low-pressure-side space LP, and the other end communicating with the pressure adjustment space 33.

A first sealing portion 61 is provided between the sealing member 31 and the low-pressure-side retainer 46. In the sealing member 31, the low-pressure-side end surface 51c in the support portion 51 is provided with a first groove portion 51e. The first groove portion 51e is provided continuously along the circumferential direction C. The first sealing portion 61 has a hollow pipe shape, is, for example, an O-ring, and has a ring shape continuous in the circumferential direction C. The first sealing portion 61 is mounted to the first groove portion 51e. When the sealing member 31 is attached to the retainer 44, that is, between the high-pressure-side retainer 45 and the low-pressure-side retainer 46, the first sealing portion 61 mounted to the first groove portion 51e of the sealing member 31 comes into contact with the high-pressure-side lateral surface 46f of the low-pressure-side retainer 46.

At the time of start of the steam turbine 10 (see FIG. 1), the steam S in the high-pressure-side space HP partially enters the recess 41 of the sealing holder 40, acts on the high-pressure-side first lateral surface 45b of the high-pressure-side retainer 45, and acts on the low-pressure-side end surface 51c of the sealing member 31. Therefore, the pressing force between the high-pressure-side retainer 45 and the sealing member 31 increases. However, since the low-pressure steam S in the low-pressure-side space LP is supplied to the pressure adjustment space 33 through the communication passage 34, the pressing force between the high-pressure-side retainer 45 and the sealing member 31 is reduced. Therefore, sliding resistance against the retainer 44 when the sealing member 31 moves in the radial direction R is reduced.

At this time, the pressing force between the high-pressure-side retainer 45 and the sealing member 31 fluctuates in accordance with the pressure-receiving area of the pressure adjustment space 33 to which the low-pressure steam S is supplied. That is, depending on the pressure-receiving area of the pressure adjustment space 33, the pressing force by which the sealing member 31 is pressed against the high-pressure-side retainer 45 side increases, a gap is formed between the low-pressure-side end surface 51c of the sealing member 31 and the high-pressure-side lateral surface 46f of the low-pressure-side retainer 46, and there is a possibility that the high-pressure steam S in the recess 41 leaks to the low-pressure-side space LP through the gap. In the second embodiment, the first sealing portion 61 is provided between the sealing member 31 and the low-pressure-side retainer 46, and leakage of the high-pressure steam S from the gap between the low-pressure-side end surface 51c of the sealing member 31 and the high-pressure-side lateral surface 46f of the low-pressure-side retainer 46 is suppressed.

### Third Embodiment

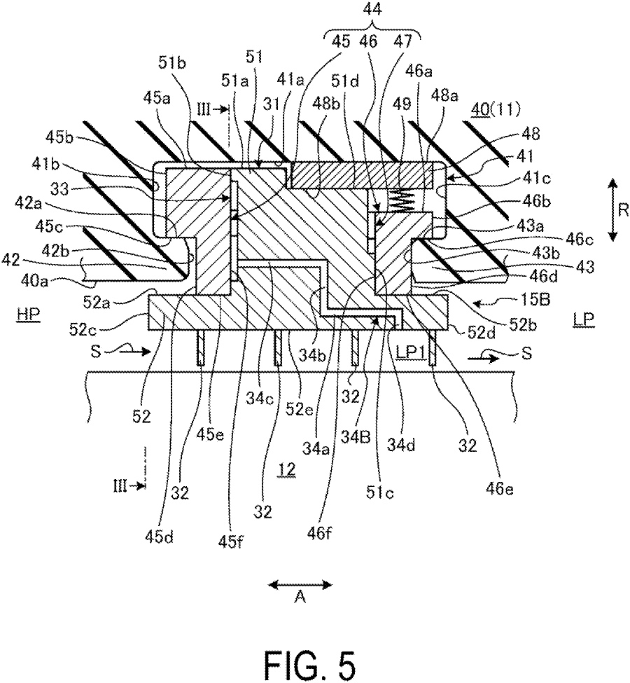

FIG. 5 is a cross-sectional view illustrating a sealing device of the third embodiment. Members having the same functions as those of the above-described first embodiment are denoted by the same reference signs, and detailed description thereof will be omitted.

As illustrated in FIG. 5, a sealing device 15B includes the sealing member 31, the seal fin 32, the pressure adjustment space 33, and a communication passage 34B.

The pressure adjustment space 33 is configured by forming a recess in the high-pressure-side end surface 51b of the sealing member 31. The pressure adjustment space 33 is brought into a sealed state when the high-pressure-side end surface 51b in the support portion 51 of the sealing member 31 and the low-pressure-side lateral surface 45f of the high-pressure-side retainer 45 come into contact with each other. The communication passage 34B has one end communicating with the low-pressure-side space LP, and the other end communicating with the pressure adjustment space 33. Specifically, the communication passage 34B has one end communicating with a first low-pressure space LP1 formed between the seal fins 32 communicating with the low-pressure-side space LP.

The communication passage 34B includes the first communication passage 34a along the axial direction A, the second communication passage 34b along the radial direction R, the third communication passage 34c along the axial direction A, and a fourth communication passage 34d along the radial direction R. The fourth communication passage 34d has one end opening to the inside surface 52e of the fin attachment portion 52. The sealing member 31 is provided with four seal fins 32 toward the rotor 12, and three spaces are defined between the sealing member 31 and the rotor 12. The fourth communication passage 34d opens in the first low-pressure-side space LP1 between the seal fin 32 closest to the low-pressure-side space LP and the seal fin 32 second closest to the low-pressure-side space LP.

The third communication passage 34c has one end opening to the low-pressure-side space LP. The second communication passage 34b has one end communicating with the other end of the first communication passage 34a. The first communication passage 34a has one end communicating with the other end of the third communication passage 34c and the other end communicating with the other end of the fourth communication passage 34d. The communication passage 34B is not limited to this configuration, and for example, the first low-pressure-side space LP1 and the pressure adjustment space 33 may be configured by one or more linear shapes. The fourth communication passage 34d may be configured to open to another low-pressure-side space between the adjacent seal fins 32.

At the time of start of the steam turbine 10 (see FIG. 1), the steam S in the high-pressure-side space HP partially enters the recess 41 of the sealing holder 40, acts on the high-pressure-side first lateral surface 45b of the high-pressure-side retainer 45, and acts on the low-pressure-side end surface 51c of the sealing member 31. Therefore, the pressing force between the high-pressure-side retainer 45 and the sealing member 31 increases. However, since the low-pressure steam S in the first low-pressure-side space LP1 is supplied to the pressure adjustment space 33 through the communication passage 34B, the pressing force between the high-pressure-side retainer 45 and the sealing member 31 is reduced. Therefore, sliding resistance against the retainer 44 when the sealing member 31 moves in the radial direction R is reduced.

### Fourth Embodiment

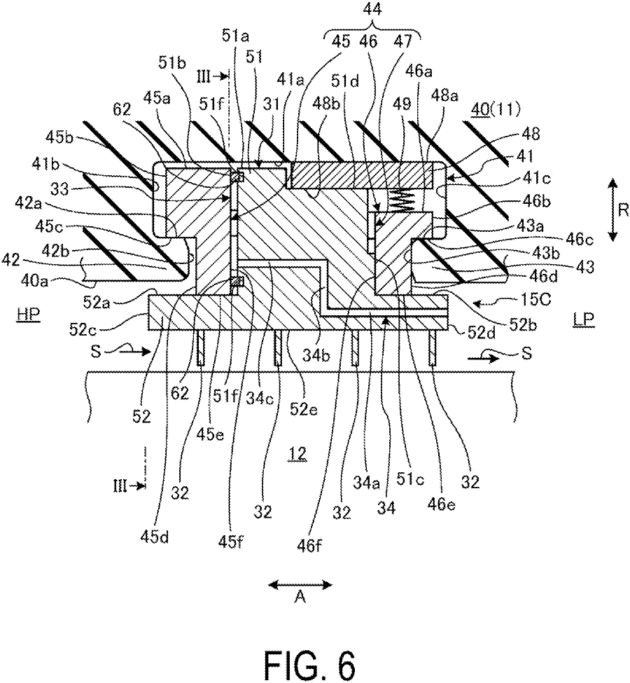

FIG. 6 is a cross-sectional view illustrating a sealing device of the fourth embodiment. Members having the same functions as those of the above-described first embodiment are denoted by the same reference signs, and detailed description thereof will be omitted.

As illustrated in FIG. 6, a sealing device 15C includes the sealing member 31, the seal fin 32, the pressure adjustment space 33, and the communication passage 34.

Two second sealing portions 62 are provided between the sealing member 31 and the high-pressure-side retainer 45. The two second sealing portions 62 are arranged at an interval in the radial direction R. The sealing member 31 is provided with two second groove portions 51f at intervals in the radial direction R on the high-pressure-side end surface 51b of the support portion 51. The two second groove portions 51f are provided continuously along the circumferential direction C. The two second sealing portions 62 each have a quadrangular cross-sectional shape and have a ring shape continuous in the circumferential direction C. The two second sealing portions 62 are respectively mounted to the second groove portions 51f.

When the sealing member 31 is attached to the retainer 44, that is, between the high-pressure-side retainer 45 and the low-pressure-side retainer 46, the second sealing portions 62 respectively mounted to the second groove portions 51f of the sealing member 31 come into contact with the low-pressure-side lateral surface 45f of the high-pressure-side retainer 45. At this time, a gap is formed between the high-pressure-side end surface 51b of the sealing member 31 and the low-pressure-side lateral surface 45f of the high-pressure-side retainer 45, and this gap is defined by the second sealing portions 62 arranged at an interval in the radial direction R. The pressure adjustment space 33 is a space defined by the high-pressure-side end surface 51b of the sealing member 31, the low-pressure-side lateral surface 45f of the high-pressure-side retainer 45, and the second sealing portions 62. The communication passage 34 has one end communicating with the low-pressure-side space LP, and the other end communicating with the pressure adjustment space 33.

At the time of start of the steam turbine 10 (see FIG. 1), the steam S in the high-pressure-side space HP partially enters the recess 41 of the sealing holder 40, acts on the high-pressure-side first lateral surface 45b of the high-pressure-side retainer 45, and acts on the low-pressure-side end surface 51c of the sealing member 31. Therefore, the pressing force between the high-pressure-side retainer 45 and the sealing member 31 increases. However, since the low-pressure steam S in the low-pressure-side space LP is supplied to the pressure adjustment space 33 through the communication passage 34, the pressing force between the high-pressure-side retainer 45 and the sealing member 31 is reduced. Therefore, sliding resistance against the retainer 44 when the sealing member 31 moves in the radial direction R is reduced.

At this time, the pressing force between the high-pressure-side retainer 45 and the sealing member 31 fluctuates in accordance with the pressure of the high-pressure steam S supplied to the high-pressure space HP. The steam S supplied to the pressure adjustment space 33 is low in pressure. When there is a gap between the high-pressure-side end surface 51b of the sealing member 31 and the low-pressure-side lateral surface 45f of the high-pressure-side retainer 45, there is a possibility that the high-pressure steam S in the recess 41 leaks to the pressure adjustment space 33 through the gap. In the fourth embodiment, the pressure adjustment space 33 is sealed by providing the second sealing portion 62 between the sealing member 31 and the high-pressure-side retainer 45, and leakage of the high-pressure steam S from the gap between the high-pressure-side end surface 51b of the sealing member 31 and the low-pressure-side lateral surface 45f of the high-pressure-side retainer 45 is suppressed.

### Fifth Embodiment

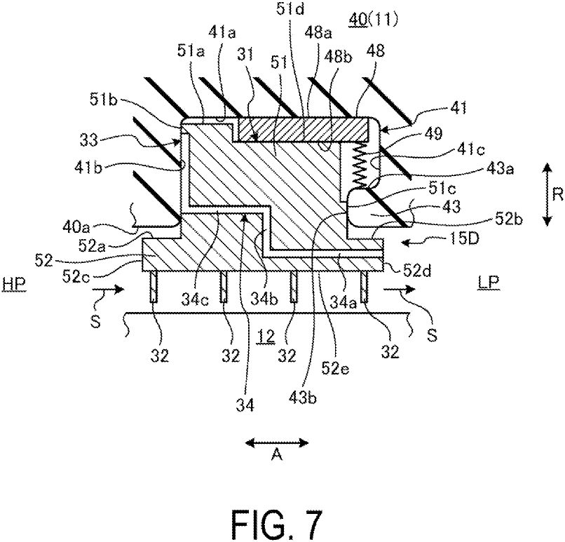

FIG. 7 is a cross-sectional view illustrating a sealing device of the fifth embodiment. Members having the same functions as those of the above-described first embodiment are denoted by the same reference signs, and detailed description thereof will be omitted.

As illustrated in FIG. 7, a sealing device 15D includes the sealing member 31, the seal fin 32, the pressure adjustment space 33, and the communication passage 34.

The sealing holder 40 is fixed to the casing 11, and the sealing holder 40 is provided with the recess 41 in the inner circumferential portion. The recess 41 is formed to be recessed outward in the radial direction R of the rotor 12 from an inside surface 40a of the sealing holder 40. The recess 41 has a bottom surface 41a, a high-pressure-side lateral surface 41b, and a low-pressure-side lateral surface 41c. The recess 41 is provided with the low-pressure-side protrusion 43 protruding on the high-pressure space HP side from inside in the radial direction R of the low-pressure-side lateral surface 41c. The low-pressure-side protrusion 43 has an inner surface 43a and a low-pressure-side lateral surface 43b.

The sealing member 31 is supported by the recess 41 of the sealing holder 40. The sealing member 31 is similar to that of the first embodiment, and includes the support portion 51 and the fin attachment portion 52. The support portion 51 has a quadrangular cross-sectional shape, and has the outside surface 51a, the high-pressure-side end surface 51b, and the low-pressure-side end surface 51c. The high-pressure-side end surface 51b of the support portion 51 opposes the high-pressure-side lateral surface 41b of the recess 41 and can come into contact therewith. The low-pressure-side end surface 51c of the support portion 51 opposes the low-pressure-side lateral surface 43b of the low-pressure-side protrusion 43 in the recess 41 and can come into contact therewith. The fin attachment portion 52 is integrally provided inside in the radial direction R of the support portion 51. The seal fin 32 extends from the fin attachment portion 52 of the sealing member 31 on the rotor 12 side.

The spring reception member 48 is fixed to the outside surface 51a side of the sealing member 31. The spring reception member 48 is fixed to the stepped portion 51d formed on the outside surface 51a of the support portion 51 in the sealing member 31. In the spring reception member 48, the outside surface 48a is disposed to oppose the bottom surface 41a of the recess 41, and the inside surface 48b is disposed to oppose the inner surface 43a of the low-pressure-side protrusion 43. The compression spring 49 is disposed between the low-pressure-side protrusion 43 and the spring reception member 48. The compression spring 49 biases the sealing member 31 via the spring reception member 48 in the radial direction R in which the seal fin 32 is separated from the rotor 12 by the biasing force.

The pressure adjustment space 33 is provided in the support portion 51 of the sealing member 31. Specifically, the pressure adjustment space 33 is provided on the high-pressure-side end surface 51b of the support portion 51 in the sealing member 31. The pressure adjustment space 33 is formed by providing the high-pressure-side end surface 51b of the sealing member 31 with a recess. The pressure adjustment space 33 opposes the high-pressure-side lateral surface 41b in the recess 41 of the sealing holder 40. That is, the pressure adjustment space 33 is a space formed between the high-pressure-side end surface 51b in the support portion 51 of the sealing member 31 and the high-pressure-side lateral surface 41b of the recess 41 when they come into contact with each other. The communication passage 34 has one end communicating with the low-pressure-side space LP, and the other end communicating with the pressure adjustment space 33.

At the time of start of the steam turbine 10 (see FIG. 1), the steam S in the high-pressure-side space HP partially leaks to the low-pressure-side space LP through the gap between the seal fin 32 and the rotor 12. The steam S partially passes through between the sealing holder 40 and the high-pressure-side retainer 45 and enters the outside surface 51a side of the support portion 51 in the sealing member 31. Then, the sealing member 31 is pressed inward in the radial direction R by the steam S in the high-pressure space HP, and moves inward in the radial direction R against the biasing force of the compression spring 49. Then, the gap between the tip portion of the seal fin 32 and the outside surface of the rotor 12 becomes small, a pressure loss occurs due to a minute gap, and a leakage flow of the steam S flowing through the gap in the axial direction A is suppressed by the pressure loss.

At this time, the steam S in the high-pressure-side space HP partially enters the recess 41 of the sealing holder 40 and acts on the low-pressure-side end surface 51c of the sealing member 31. Therefore, the pressing force with the sealing member 31 with respect to the high-pressure-side lateral surface 31b of the recess 41 increases. However, since the low-pressure steam S in the low-pressure-side space LP is supplied to the pressure adjustment space 33 through the communication passage 34, the pressing force of the sealing member 31 against the high-pressure-side lateral surface 31b of the recess 41 is reduced. Therefore, sliding resistance against the retainer 44 when the sealing member 31 moves in the radial direction R is reduced. As a result, the sealing member 31 can smoothly move in the radial direction R in accordance with the differential pressure between the high-pressure-side space HP and the low-pressure-side space LP.

When the pressure of the steam S in the high-pressure-side space HP fluctuates, the pressing force with the sealing member 31 against the high-pressure-side lateral surface 31b of the recess 41 fluctuates. At this time, the differential pressure between the high-pressure-side space HP and the low-pressure-side space LP also fluctuates. That is, the pressing force of the sealing member 31 against the high-pressure-side lateral surface 31b of the recess 41 is appropriately adjusted in accordance with the fluctuation of the high-pressure-side space HP. As a result, the sliding resistance of the recess 41 against the sealing holder 40 when the sealing member 31 moves in the radial direction R is appropriately adjusted.

### Actions and Effects of Present Embodiment

A sealing device according to a first aspect is the sealing device 15, 15A, 15B, 15C, or 15D disposed between the casing (stationary body) 11 and the rotor (rotating body) 12 and configured to suppress flow of the steam (fluid) S from the high-pressure-side space HP to the low-pressure-side space LP. The sealing device includes: the sealing member 31 movably supported by the casing 11 in the axial direction A and the radial direction R of the rotor 12, the seal fin 32 extending from the sealing member 31 to the rotor 12 side, the pressure adjustment space 33 provided between the casing 11 and the high-pressure-side end surface 51b in the sealing member 31; and the communication passage 34 or 34B having end communicating with the low-pressure-side space LP and the other end communicating with the pressure adjustment space 33.

According to the sealing device according to the first aspect, the sealing member 31 is pressed against the casing 11 by the pressure of the steam S in the high-pressure-side space HP, and the sliding resistance when moving in the radial direction R increases. However, since the steam S in the low-pressure-side space LP is supplied to the pressure adjustment space 33 through the communication passage 34, the pressing force of the sealing member 31 pressed against the casing 11 is reduced. Therefore, the sliding resistance against the casing 11 when the sealing member 31 moves in the radial direction R is reduced. As a result, the sealing member 31 can smoothly move in the radial direction R in accordance with the differential pressure between the high-pressure-side space HP and the low-pressure-side space LP.

When the pressure of the steam S in the high-pressure-side space HP fluctuates, the pressing force of the sealing member 31 against the casing 11 fluctuates. At this time, the differential pressure between the high-pressure-side space HP and the low-pressure-side space LP also fluctuates. That is, the pressing force of the sealing member 31 against the casing 11 is appropriately adjusted in accordance with the fluctuation of the high-pressure-side space HP. Therefore, the sliding resistance against the casing 11 when the sealing member 31 moves in the radial direction R is appropriately adjusted. As a result, it is possible to maintain stable sealing performance by smoothly operating a sealing member 31 regardless of pressure fluctuation.

The sealing device according to the second aspect is provided with the pressure adjustment space 33 along the circumferential direction C of the rotor 12, and the communication passage 34 or 34B is provided along the axial direction A of the rotor 12 and the plurality of them are provided at intervals in the circumferential direction C of the rotor 12. Due to this, the steam S in the low-pressure-side space LP is appropriately supplied to the pressure adjustment space 33 through the communication passage 34, and the sliding resistance of the sealing member 31 can be appropriately adjusted over the entire circumference.

In the sealing device according to the third aspect, the casing 11 is provided with the recess 41 recessed outward in the radial direction R of the rotor 12, the sealing member 31 includes the support portion 51 disposed in the recess 41 and the fin attachment portion 52 extending from the support portion 51 to the rotor 12 side, and the pressure adjustment space 33 is provided in the support portion 51. Due to this, by providing the pressure adjustment space 33 in the support portion 51 arranged in the recess 41, it is possible to appropriately reduce the sliding resistance of the sealing member 31 with respect to the recess 41.

In the sealing device according to the fourth aspect, the retainer 44 is mounted in the recess 41 of the casing 11, and the support portion 51 of the sealing member 31 is supported by the retainer 44. Due to this, use of the retainer 44 allows the sealing member 31 to be mounted on the casing 11 with high accuracy regardless of the size and shape of the recess 41.

In the sealing device according to the fifth aspect, the communication passage 34 or 34B communicates with the low-pressure-side space LP by having one end of the communication passage 34 or 34B opening to the fin attachment portion 52. This makes it possible to appropriately supply the steam S in the low-pressure-side space LP to the pressure adjustment space 33 through the communication passage 34.

In a sealing device according to a sixth aspect, the plurality of seal fins 32 are provided at intervals in the axial direction A of the rotor 12, and the communication passage 34B has one end communicating with the first low-pressure-side space LP1 between the plurality of seal fins 32. Due to this, by supplying the relatively high steam S to the pressure adjustment space 33, it is possible to expand an adjustment margin of the sliding resistance of the sealing member 31.

In a sealing device according to a seventh aspect, the first sealing portion 61 is provided between the casing 11 (low-pressure-side retainer 46) and the low-pressure-side end surface 51c of the sealing member 31. This makes it possible to suppress leakage of the steam S from the gap between the casing 11 (low-pressure-side retainer 46) and the sealing member 31 regardless of the pressure-receiving area of the pressure adjustment space 33.

In a sealing device according to an eighth aspect, the second sealing portion 62 is provided in the pressure adjustment space 33, both inside and outside in the radial direction R of the rotor 12, between the casing 11 (high-pressure-side retainer 45) and the high-pressure-side end surface 51b of the sealing member 31. This makes it possible to suppress leakage of the steam S from the gap between the casing 11 (low-pressure-side retainer 46) and the sealing member 31.

A sealing device according to a ninth aspect further includes the compression spring (biasing member) 49 configured to bias the sealing member 31 in a direction in which the seal fin 32 is separated from the rotor 12. This makes it possible to appropriately move the seal fin 32 to a separation position separated from the rotor 12 and a seal position (approach position) approaching the rotor 12.

A rotary machine according to a tenth aspect includes the casing (stationary body) 11, the rotor (rotating body) 12 rotatably supported by the casing 11, and the sealing device 15, 15A, 15B, 15C, 15D disposed between the casing 11 and the rotor 12. Due to this, by smoothly operating the sealing member 31 regardless of pressure fluctuation, it is possible to maintain stable sealing performance, and suppress deterioration in performance.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A sealing device disposed between a stationary body and a rotating body and configured to suppress flow of a fluid from a high-pressure side to a low-pressure side, the sealing device comprising:
a sealing member movably supported by the stationary body in an axial direction and a radial direction of the rotating body;
a seal fin extending from the sealing member to the rotating body side;
a pressure adjustment space provided between the stationary body and a high-pressure-side end surface of the sealing member; and
a communication passage having one end communicating with the low-pressure side and an other end communicating with the pressure adjustment space.

2. The sealing device according to claim 1, wherein
the pressure adjustment space is provided along a circumferential direction of the rotating body, and
a plurality of the communication passages are provided at intervals in a circumferential direction of the rotating body, along an axial direction of the rotating body.

3. The sealing device according to claim 1, wherein
the stationary body is provided with a recess recessed outward in a radial direction of the rotating body,
the sealing member includes a support portion disposed in the recess and a fin attachment portion extending from the support portion to the rotating body side, and
the pressure adjustment space is provided in the support portion.

4. The sealing device according to claim 3, wherein
the stationary body includes a retainer mounted in the recess, and
the support portion of the sealing member is supported by the retainer.

5. The sealing device according to claim 3, wherein
the communication passage communicates with the low-pressure side by having one end opening to the fin attachment portion.

6. The sealing device according to claim 1, wherein
a plurality of the seal fins are provided at intervals in an axial direction of the rotating body, and
the communication passage has one end communicating between the plurality of seal fins.

7. The sealing device according to claim 1, wherein
a first sealing portion is provided between the stationary body and a low-pressure-side end surface of the sealing member.

8. The sealing device according to claim 1, wherein
a second sealing portion is provided in the pressure adjustment space, both inward and outward of the radial direction of the rotating body, between the stationary body and the high-pressure-side end surface.

9. The sealing device according to claim 1, further comprising:
a biasing member configured to bias the sealing member in a direction in which the seal fin is separated from the rotating body.

10. A rotary machine comprising:
a stationary body;
a rotating body rotatably supported by the stationary body; and
the sealing device described in claim 1, the sealing device being disposed between the stationary body and the rotating body.
